(19) United States
(12) Patent Application Publication
(10) Pub. No.: US 2025/0123126 A1
(43) Pub. Date: Apr. 17, 2025

(54) SYSTEMS AND METHODS FOR VIBRATION REDUCTION IN ENCODER-BASED GALVANOMETERS

(71) Applicant: Novanta Corporation, Bedford, MA (US)

(72) Inventors: Roy ALLEN, North Andover, MA (US); Brendan BOYD, Somerville, MA (US); Kurt SIDOR, Plaistow, NH (US)

(21) Appl. No.: 18/918,224

(22) Filed: Oct. 17, 2024

Related U.S. Application Data
(60) Provisional application No. 63/544,542, filed on Oct. 17, 2023.

(51) Int. Cl. G01D 5/347; H02K 11/22

(52) U.S. Cl. CPC G01D 5/34715; H02K 11/22

(57) ABSTRACT

An encoder-based galvanometer system is adapted for reducing vibrations within the galvanometer through the placement of structural elements and vibration reducing dampening materials within the encoder. The disclosed system and method provide for a reduction in positioning errors and the improved dynamic performance in an encoder-based galvanometer system.

### PRIORITY

This application claims priority to U.S. Provisional Patent Application No. 63/544,542 filed Oct. 17, 2023, the entirety of which is incorporated herein by reference for all purposes.

### BACKGROUND

The invention generally relates to galvanometers and relates in particular to encoder-based galvanometers.

Applications for encoder-based galvanometers have become more demanding, particularly for via hole drilling applications. In via hole drilling applications, printed circuit board assemblies (PCBAs) can have many thousands of holes per workpiece. The throughputs for such laser drilling applications are often in excess of 1000 holes per second. Therefore, the time it takes to come to within the target position for each hole, or settling time, has become an important metric for galvanometer performance.

State-of-the-art galvanometers must therefore be able to rapidly accelerate a mirror to a commanded position and settle within a specified accuracy before a laser can be fired to drill a hole. The settling time is dependent on the many resonant frequencies of the mechanical system whose response to the commanded acceleration may cause the system to have positioning errors outside of the desired time window.

While certain prior art galvanometer systems may employ damping within the galvanometer for damping vibration, it is also important to not negatively impact the stiffness needed for rapid acceleration.

There remains a need therefore for a more efficient and economical encoder-based galvanometer system that provides improved settling time without negatively impacting other aspects of the performance of the galvanometer and encoder systems, including for example, rotor responsiveness, inertial constraints, and encoder accuracy.

### SUMMARY

In accordance with an aspect, the invention provides an encoder system for a galvanometer including an emitter system including at least one emitter for providing illumination, a detector system including at least one detector for detecting illumination, an encoder disc coupled to a rotor of the galvanometer, a rigid structure positioned between the emitter system and the detector system such that the illumination may pass through the rigid structure; and a damping system including at least polymeric material positioned in contact with any of the emitter system and the detector system.

In accordance with another aspect, the invention provides a galvanometer system including a stator assembly, a rotor within the stator assembly; and an encoder system including an emitter system including at least one emitter for providing illumination, a detector system including at least one detector for detecting illumination, an encoder disc coupled to a rotor of the galvanometer; and a damping system including at least polymeric material positioned in contact with any of the emitter system and the detector system.

In accordance with a further aspect, the invention provides a method of operating a galvanometer that includes the steps of engaging rotation of a rotor within a stator, rotating an encoder disc of an encoder system with the rotor, the encoder disc being coupled to the rotor and housed within the encoder system that includes an emitter system, a detector system and the encoder disc, and damping vibrations that emanate from within the encoder system with at least polymeric material positioned in contact with any of the emitter system and the detector system.

### BRIEF DESCRIPTION OF THE DRAWINGS

The following description may be further understood with reference to the accompanying drawings in which:

FIG. 1 shows an illustrative diagrammatic cross-sectional view of a system in accordance with an aspect of the present invention;

FIG. 2 shows the illustrative diagrammatic cross-sectional view of the system according to FIG. 1 in an operational configuration;

FIG. 3 shows an illustrative diagrammatic isometric exploded view of a subassembly of the encoder of the present invention;

FIG. 4 shows an illustrative diagrammatic isometric view of an aspect of the present invention;

FIG. 5 s shows an illustrative diagrammatic isometric view of another aspect of the present invention;

FIGS. 6A and 6B show an illustrative diagrammatic view of a mounting standoff according to an aspect of the present invention in an isometric view (FIG. 6A) and a top elevation view (FIG. 6B);

FIGS. 7A and 7B show an illustrative diagrammatic view of a mounting standoff according to another aspect of the present invention in an isometric view (FIG. 7A) and a top elevation view (FIG. 7B);

FIGS. 8A and 8B depict an illustrative diagrammatic view of a galvanometer rotor subassembly according to an aspect of the present invention in an isometric view from above (FIG. 8A) and from below (FIG. 8B);

FIG. 9 shows an illustrative diagrammatic partially exploded view of an aspect of the invention depicting the encoder subassembly with the encoder disk mounted to the rotor.

The drawings are shown for illustrative purposes only.

### DETAILED DESCRIPTION

In accordance with various aspects, the invention provides systems and methods for a more efficient and economical encoder-based galvanometer system that provides improved settling time without negatively impacting the performance of the galvanometer and encoder systems, including, for example, rotor responsiveness, inertial constraints, and encoder accuracy.

Applicants have discovered that certain errors in encoder-based galvanometer systems are caused by vibration of and/or within the encoder structure, and further that these may be mitigated through various mechanical means to achieve optimal performance. Some of these means of mitigating vibrational errors generally include material selection, geometry design of the mechanical structure in order to isolate critical optical components from the rest of the moving parts of the galvanometer that induce vibration.

In accordance with an aspect, the invention provides a method for reducing vibrations within an encoder-based galvanometer through the geometry and placement of structural elements and dampeners within the encoder. The system of various aspects of the invention provides for the reduction of positioning errors and for the improved dynamic performance of encoder-based galvanometers.

Systems of various aspects of the invention provide for improvements in dynamic performance, and have applications, for example, in the via hole drilling (VHD) market; this enables such systems to potentially be driven much faster with higher power. Mechanical innovations of certain aspects of the invention further enables forward compatibility in galvanometers with new servo drivers that are able to deliver more power. Another benefit of systems of certain aspects includes providing a more mechanically stable galvanometer design allowing for higher accuracy across other applications for wider applications. Additionally, some of the vibration reduction methods described herein may be applied in other galvanometer designs.

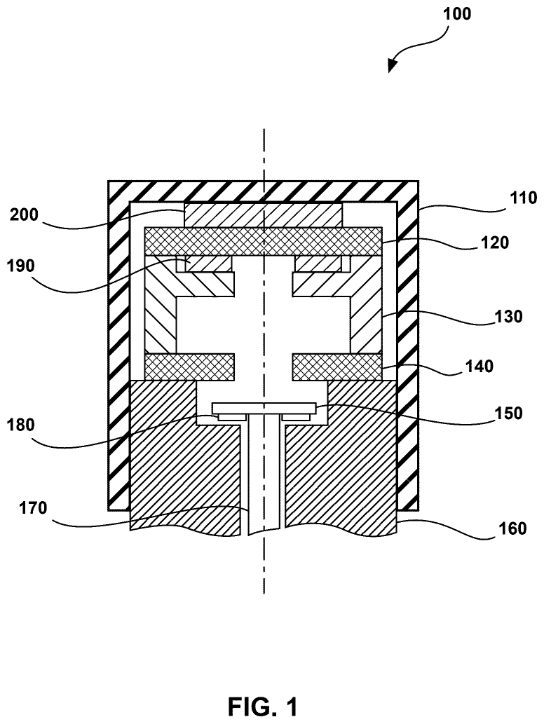

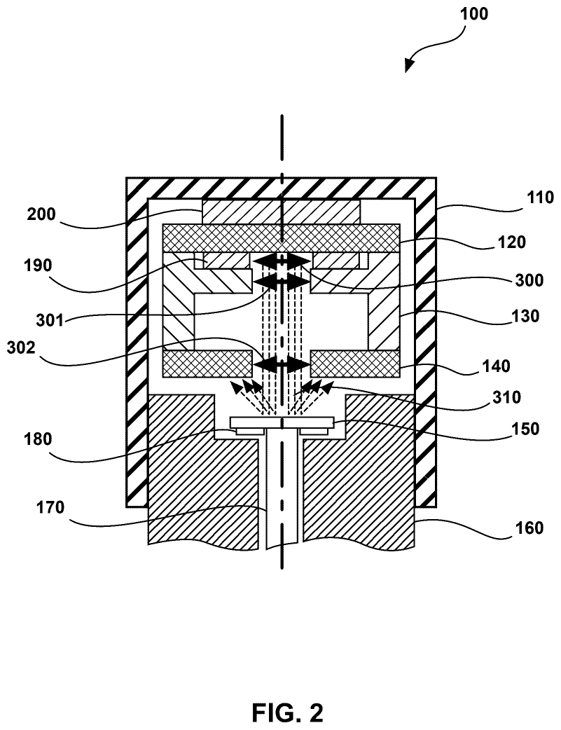

In accordance with certain aspects, the present invention provides a method by which the vibrational errors associated with a galvanometer's encoder are mitigated through the placement of viscoelastic material in selected places within the encoder assembly. An example of such an encoder is shown in FIGS. 1 and 2. FIG. 1 shows a cross-sectional view of an encoder-based galvanometer system 100 that includes vibration damping in accordance with an aspect of the present invention, and FIG. 2 shows the system with light being emitted and detected. The system 100 includes a detector board (detector PCBA) 140 that is includes a window 302 (as shown in FIG. 2) through which light 310 from an emitter board (emitter PCBA) 120 reaches an encoder disk 150 that rotates with a rotor 170 within a motor assembly 160 of the galvanometer system 100.

The cross-sectional view of FIG. 1 shows the encoder side of the galvanometer in which the cover 110 encloses and protects the encoder hardware. The emitter board 120 is securely mounted at a specific focal distance from the encoder disk 150 on integrated standoffs 130 to prevent motion relative to both the detector board 140 and the encoder disk 150. The encoder disk 150 is comprised of a glass disk with graduated optical markings used for detecting angular position. The motor assembly 160 includes a stator and a housing, and the rotor rotates within the stator. Damping is provided by the elastomeric disk 180 (for the encoder disk), by the elastomeric disk 190 (at the top light emitting side of the emitter board), and by the elastomeric component 200 (at the bottom, light emitting side of the emitter board).

The detector board 140 is mounted on the motor assembly 160 and the emitter board 120 is mounted on integrated standoffs 130 within a housing cover 110. On the emitter-side of the emitter board 120 is an elastomeric material 190 between the emitter board 120 and the integrated standoffs 130. The elastomeric material 190 includes a window 300 through which the light passes, and the integrated standoffs 130 also provide a window 301 through which the light passes. An elastomeric material 300 is provided on the opposing (top) side of the emitter board 120 between the emitter board 120 and the cover 110. An elastomeric disk material 180 is also provided on the non-reflecting side of the detector board 140.

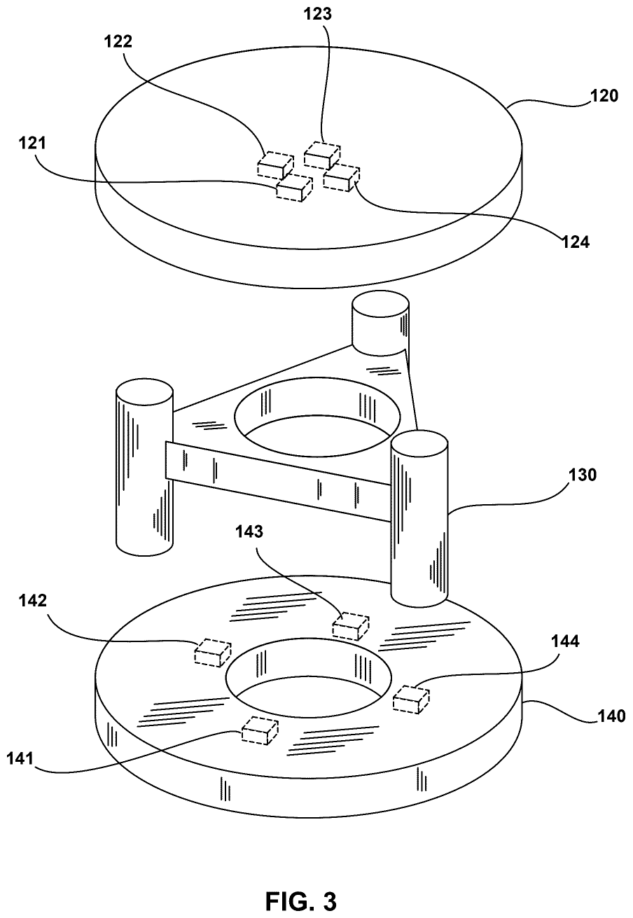

The light passes from the emitter board 120 and concentrically arranged, with the emitter board 120 above the detector board 140, and having an opening, herein referred to as the detector board window 302, through which the emitted light 310, from the LEDs 121, 122, 123, 124 (not visible and shown as outline in FIG. 3), located on the emitter board 310, is able to be projected through and onto an optically patterned encoder disk 150 on the encoder end of the galvanometer rotor 170. The light projected onto the optically patterned encoder disk 150, is then reflected back onto the detector board's photodetectors 141, 142, 143, 144 (also shown in FIG. 3) for the encoding of a precise angular position of the rotor 170.

The cross-sectional view of FIG. 2 shows the encoder side of a galvanometer depicting the optical path, showing the opening 300 in the bottom elastomer 190 through which light passes from the emitter. FIG. 2 also shows the opening 301 in the integrated standoffs 130, through which light passes from the emitter, and shows the opening 302 in the detector board 140, through which light passes from the emitter. FIG. 2 further shows the light 310 emitted from the emitter, reflected off of the encoder disk and detected by the detector.

The position of the emitter board 120 is intended to be stationary and without any vibrational displacement with respect to the detector board 140 so that errors are not introduced in the measured angular position of the encoder disk 150. This relative position between the emitter board and detector board is therefore controlled by means of a rigid support between them, referred to herein as integrated standoffs 130, and elastomeric damping materials, secured and compressed at the top 200 and bottom 190 of the emitter board 120. The elastomeric material at the top of the emitter board 200 is compressed against the inside top of the encoder cover 110 to secure it in place and allow the elastomeric material to absorb vibrational energy from the cover and or the emitter board. The elastomeric material at the bottom of the emitter board 190 is compressed and secured in place between the emitter board and integrated standoffs 130.

The integrated standoffs 130 have a dual purpose whereby the emitter board is supported at a precise optical distance from the encoder disk and the elastomeric material beneath the emitter board is secured and compressed firmly against the bottom of the emitter board. To accomplish the latter stated purpose, the integrated standoffs 130 incorporate a supporting platform 132 or members 133 in the design, which are at a precise height to secure the elastomeric material in place and absorb vibrational energy from the emitter board. The elastomeric material at the bottom of the emitter board 190 also has an opening or window 300 through which light emitted from the LEDs 121, 122, 123, and 124 can pass through and onto the encoder disk 150. Likewise, the integrated standoffs, 130, as well as the detector board 140 have an opening or window 301 and 302 respectively, through which light emitted from the LEDs 121, 122, 123, 124, can pass through and onto the encoder disk 150.

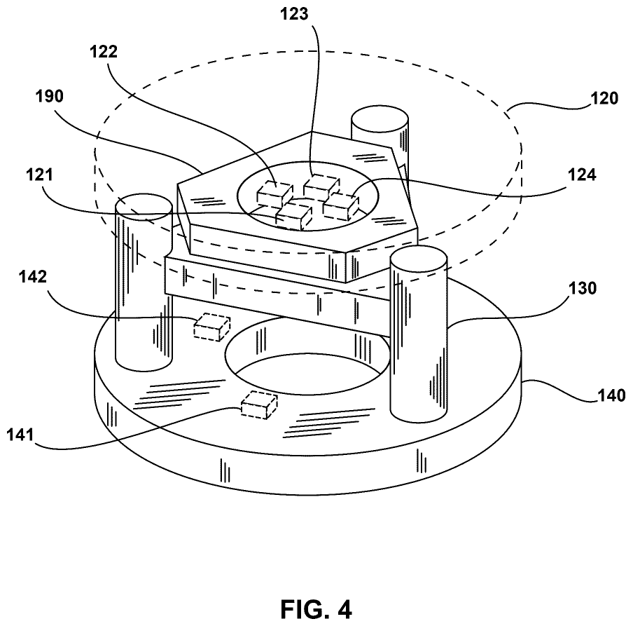

FIG. 3 shows a subassembly of the encoder in an exploded view showing the relative position of the integrated standoffs with respect to the emitter and detector boards, wherein the LEDs 121, 122, 123, 124 (not visible and therefore shown as outline) are mounted to the bottom of the emitter board 120, and the photodetectors 141, 142, 143, 144 are mounted to the bottom (not visible and therefore shown in outline) of the detector board 140. FIG. 4 shows a subassembly of the encoder showing the position of the bottom elastomer 190 with respect to the integrated standoffs. FIG. 4 also shows the emitter board 120 (in outline for clarity) and detector board 140, wherein the triangular shaped elastomer component 190 is shown with the hole in its center, and is positioned at the bottom of the emitter board 120 within the integrated standoffs 130.

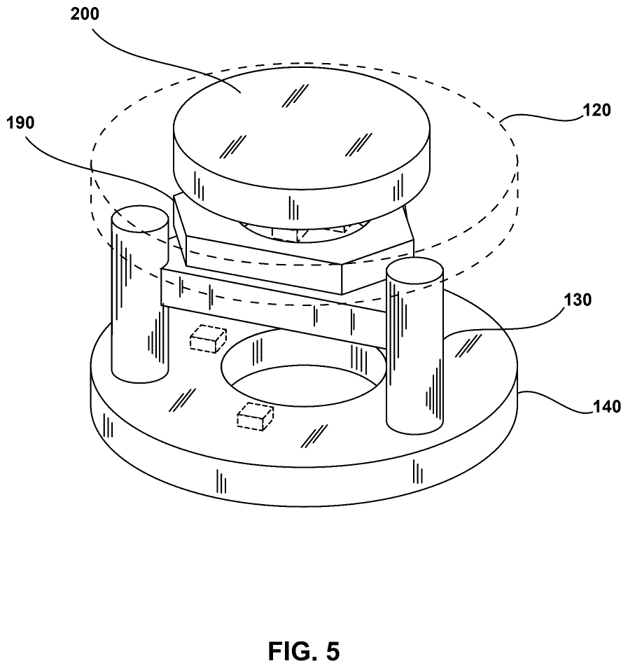

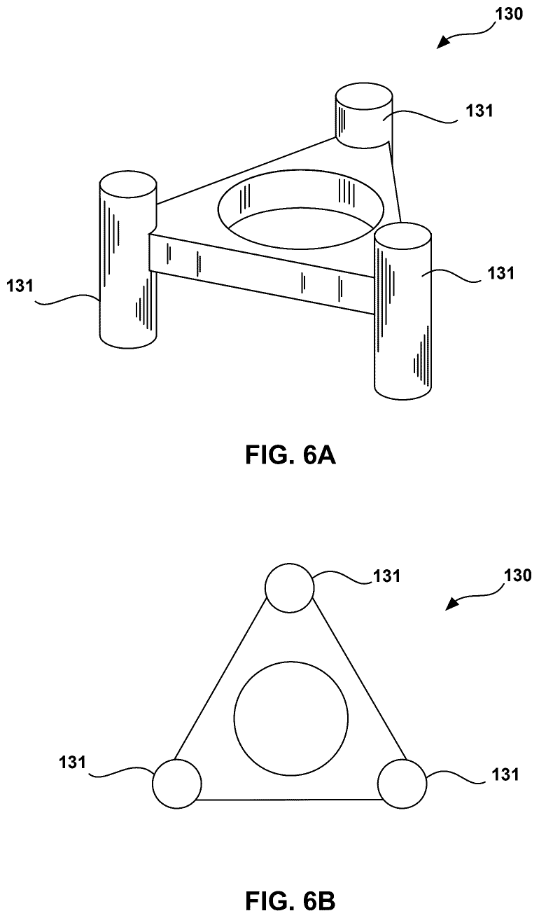

FIG. 5 shows a subassembly of the encoder showing the position of the top elastomer 200 on top of the emitter board 120 (again, shown in outline for clarity), which is mounted on the integrated standoffs opposite the detector board 140. FIGS. 6A and 6B show the integrated mounting standoffs 130 for the encoder PCBA, wherein a single rigid component is used that takes up minimal volume and provides stiffness. The integrated mounting standoffs 130 includes separate standoff posts 131 that are integrally formed with a structural member 132. Shown are three standoff posts 131 though one skilled in the art will appreciate the number and relative position of the standoff posts 131 need not be so limited. The structural member 132 serves as a platform onto which a damper can be mounted.

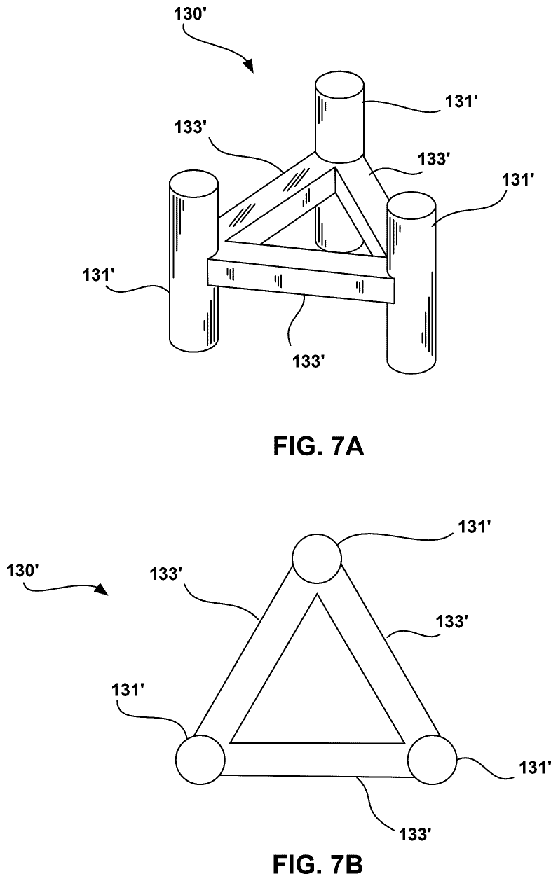

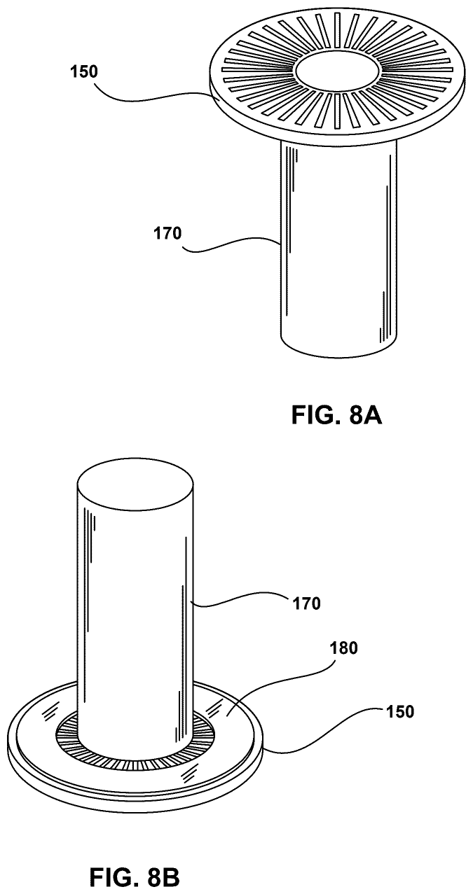

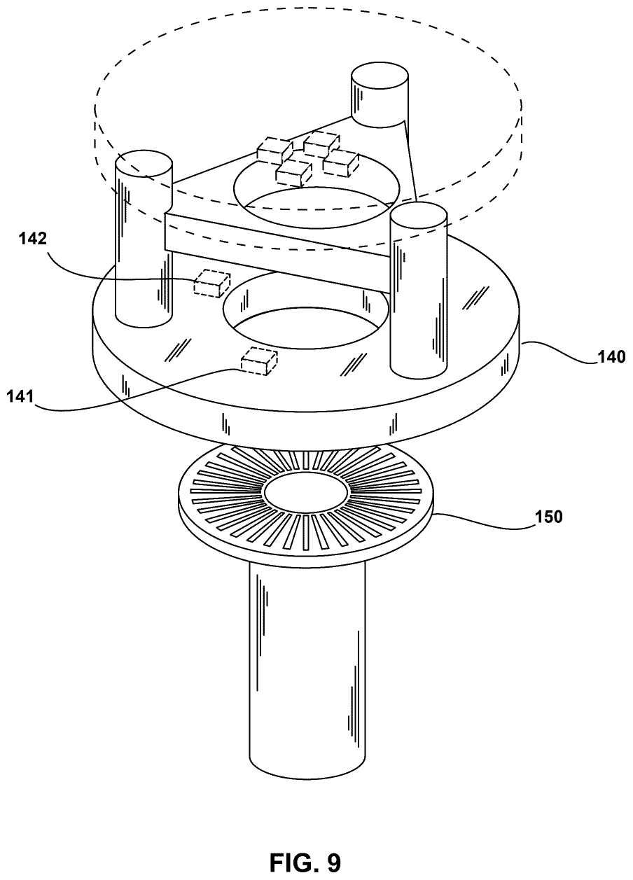

FIGS. 7A and 7B show an alternative integrated mounting standoff 130′ that comprises a single rigid component with structural members 133′ connecting separate standoffs 131′ onto which a damper can be mounted. FIGS. 8A and 8B show a subassembly of the galvanometer rotor 170, encoder disk 150 and damper 180, wherein the damper comprises an elastomer disk damper mounted to the non-optical side of the encoder disk. FIG. 9 shows a subassembly of the encoder in a partial exploded view showing the relative position of the encoder disk mounted to the rotor 150 to the detector board 140 and photodetector 141 and photodetector 142 (shown as outline, with photodetector 143 and photodetector 144 being obstructed from view).

Systems in accordance with various aspects of the present invention dampen vibrations within an encoder-based galvanometer for the purpose of improving settling time and or positioning accuracy for various commanded step sizes. The dampers described herein are placed in specific areas to target vibrations associated with the natural frequencies of major components within the encoder. These areas of placement include the encoder's cover, the emitter PCBA and the encoder disk mounted on the rotor.

Suitable damping materials for elastomer 190, elastomer 200, and elastomer disk 180 may include a wide range of different viscoelastic materials that are a subset of polymers and have both elastic and viscous properties. Having an elastic property allows the material to retain its shape after absorbing vibrational energy. Some specific material candidates for this design include but are not limited to: neoprene, silicone, polyurethane and Sorbothane® material sold by Sorbothane, Inc. of Kent, OH. Any number of these materials could be used in combination to achieve some beneficial effect. Alternatively, vibration dampening may also be achieved through the use of viscous fluids if they were able to be contained. Another possible option might include the use of an expandable polymer foam, which could be injected into the encoder cover; the exact placement of dampening material would need to be carefully controlled.

The placement of the damping materials is in three main areas within the encoder that are of concern for error causing vibrations. These three main areas include the encoder's cover 110, emitter PCBA 120 and the encoder disk 150 mounted to the rotor 170. The placement of material may be effective in any of these main areas if enough surface contact is made between the damping material, those components and an opposing rigid surface that is mechanically grounded to a more stable portion of the galvanometer. The damping materials may be able to achieve this by being single or separated parts and distributed any number of ways over the surface areas to be treated.

The vibration damping components may be cut or molded into any number of shapes to achieve some benefit. They may also be shaped in such ways to make the assembly more reliable by avoiding interference with other critical components in the assembly. They may also be shaped or formed in such ways to ease assembly. For example, some molded components may provide ridges, grooves or press-fit features to allow more precise placement during manual assembly or else moving out of place during the remaining assembly process.

The advantage of providing damping materials within the encoder is to provide faster settling times for mirror positioning and thus improving overall dynamic performance of the galvanometer in laser steering applications. In accordance with various aspects, the invention provides an encoder for a limited rotation motor wherein a vibration damper is placed between the non-light emitting side of a perforated circuit board serving as an emitter and the inside surface of a protective cover for an encoder. The vibration damper may be comprised of one or more viscoelastic materials with a durometer of between about 30 Shore 00 durometer and about 90 Shore 00 durometer, and preferably between about 40 Shore 00 durometer and about 70 Shore 00 durometer. The viscoelastic material may have a thickness of between about 1.5 mm and about 4 mm, and preferable between about 2 mm and 3 mm. The vibration damping may be provided by one, two or more separate parts, and may have an integrated feature allowing it to be attached within its assembly without falling out of place. In particular, the integrated features may include a sizing that causes the vibration damping material to snugly fit within an opening of a receiving surface of any of the emitter printed circuit board and the detector printed circuit board. The vibration damper may also have an integrated feature allowing it to be self-aligned within its assembly, again by providing a receiving surface that permits the vibration damping material to snugly fit within the receiving surface of, for example, the printed circuit board of the emitter or the detector.

In accordance with further aspects, the invention provides an encoder for a limited rotation motor wherein a vibration damper is placed between the light emitting side of a perforated circuit board serving as an emitter and a surface that is part of a rigid structure meant to constrain the emitter relative to the detector. The vibration damper may be comprised of one or more viscoelastic materials. The vibration damper may be formed of one or more separate parts as discussed above and may be positioned such that light can pass from the light emitting side of a perforated circuit board through, for example a circular hole. The vibration damper may further include an integrated feature allowing it to be attached within its assembly without falling out of place, and may include an integrated feature allowing it to be self-aligned within its assembly.

In accordance with further aspects, the invention provides a rigid structure that is a single solid component is placed between an emitter and a detector and has three or more support points on which to mount a perforated circuit board. The rigid structure may be provided as an integrated platform that supports a vibration damper, and the vibration damper may be formed of an elastomeric material. The rigid material may be machined out of a single piece of metal, or may be cast out of a single piece of metal. The rigid material may be placed between the emitter and detector may include three or more perforated circuit board (PCB) standoffs joined by means of two or more structural members between the standoffs. The rigid structure may further include a structural member between two or more PCB standoffs that support a vibration damper.

In accordance with further aspects, the invention provides an encoder for a limited rotation motor wherein a vibration damper is mounted to the non-optical side of an encoder disk that is mounted to a rotor. Again, the vibration damper may be comprised of one or more viscoelastic materials and may have a geometry that is a flat ring. The flat ring may be concentrically located with respect to the disk's center of rotation and whose inside diameter is greater than the diameter of the rotor to which it is mounted. The vibration damper may again, have an integrated feature allowing it to be attached within its assembly without falling out of place, and/or may have an integrated feature allowing it to be self-centered on the encoder disk or rotor.

In accordance with further aspects, the invention provides a rigid structure onto which a PCBA that serves as an emitter is mounted, and that reduces relative motion between the emitter and detector and allows light to pass from the emitter to the detector. The rigid structure may have a hole through which light can pass, may be optimized for minimum volume and compactness, may have a natural frequency above 2.0 KHz, may have an integrated platform supports a vibration damper, may be made out of a single piece of metal or may be made of an assembly of rigid members.

Those skilled in the art will appreciate that numerous modifications and variations may be made to the above disclosed embodiments without departing from the spirit and scope of the present invention.

What is claimed is:

1. An encoder system for a galvanometer, said encoder system comprising:
an emitter system including at least one emitter for providing illumination;
a detector system including at least one detector for detecting illumination;
an encoder disc coupled to a rotor of the galvanometer;
a rigid structure positioned between the emitter system and the detector system such that the illumination may pass through the rigid structure; and
a damping system including at least polymeric material positioned in contact with any of the emitter system and the detector system.

2. The encoder system of claim 1, wherein the emitter system includes an emitter printed circuit board and the damping system includes an elastomeric material on at least one side of the printed circuit board.

3. The encoder system of claim 2, wherein the emitter system includes an emitter printed circuit board and the damping system includes a first material on a first side of the emitter printed circuit board and a second elastomeric material on a second side of the emitter printed circuit board that is opposite the first side of the printed circuit board.

4. The encoder system of claim 1, wherein the detector system includes a detector printed circuit board and the damping system includes an elastomeric material one side of the detector printed circuit board.

5. The encoder system of claim 1, wherein the damping system includes an elastomeric material on a back side of the encoder disc.

6. The encoder system of claim 1, wherein the emitter system includes an emitter printed circuit board and the damping system includes a first material on a first side of the emitter printed circuit board, a second elastomeric material on a second side of the emitter printed circuit board that is opposite the first side of the printed circuit board, and a third elastomeric material on a back side of the encoder disc.

7. The encoder system of claim 6, wherein the first elastomeric material, the second elastomeric material and the third elastomeric material each have a durometer of between about 30 Shore 00 durometer and 90 Shore 00 durometer.

8. The encoder system of claim 6, wherein the first elastomeric material, the second elastomeric material and the third elastomeric material each have a thickness of at least about 2 mm.

9. The encoder system of claim 6, wherein at least one of the first elastomeric material, the second elastomeric material and the third elastomeric material is sized to fit within a recessed area of a respective receiving surface.

10. The encoder system of claim 1, wherein the rigid structure is integrally formed as a unitary structure.

11. A galvanometer system comprising:
stator assembly;
a rotor within the stator assembly; and
an encoder system including:
an emitter system including at least one emitter for providing illumination;
a detector system including at least one detector for detecting illumination;
an encoder disc coupled to a rotor of the galvanometer; and
a damping system including at least polymeric material positioned in contact with any of the emitter system and the detector system.

12. The galvanometer system of claim 11, wherein the encoder system further includes a rigid structure positioned between the emitter system and the detector system such that the illumination may pass through the rigid structure.

13. The galvanometer system of claim 11, wherein the emitter system includes an emitter printed circuit board and the damping system includes an elastomeric material on at least one side of the printed circuit board.

14. The galvanometer system of claim 13, wherein the emitter system includes an emitter printed circuit board and the damping system includes a first material on a first side of the emitter printed circuit board and a second elastomeric materials a second side of the emitter printed circuit board that is opposite the first side of the printed circuit board.

15. The galvanometer system of claim 11, wherein the detector system includes a detector printed circuit board and the damping system includes an elastomeric material one side of the detector printed circuit board.

16. The galvanometer system of claim 11, wherein the damping system includes an elastomeric material on a back side of the encoder disc.

17. The galvanometer system of claim 11, wherein the emitter system includes an emitter printed circuit board and the damping system includes a first material on a first side of the emitter printed circuit board, a second elastomeric material on a second side of the emitter printed circuit board that is opposite the first side of the printed circuit board, and a third elastomeric material on a back side of the encoder disc.

18. The galvanometer system of claim 17, wherein the first elastomeric material, the second elastomeric material and the third elastomeric material each have a durometer of between about 30 Shore 00 durometer and 90 Shore 00 durometer.

19. The galvanometer system of claim 17, wherein the first elastomeric material, the second elastomeric material and the third elastomeric material each have a thickness of at least about 2 mm.

20. The galvanometer system of claim 17, wherein at least one of the first elastomeric material, the second elastomeric material and the third elastomeric material is sized to fit within a recessed area of a respective receiving surface.

21. The galvanometer system of claim 11, wherein the rigid structure is integrally formed as a unitary structure.

22. A method of operating a galvanometer, said method comprising:
engaging rotation of a rotor within a stator;
rotating an encoder disc of an encoder system with the rotor, the encoder disc being coupled to the rotor and housed within the encoder system that includes an emitter system, a detector system and the encoder disc; and
damping vibrations that emanate from within the encoder system with at least polymeric material positioned in contact with any of the emitter system and the detector system.

23. The method of claim 22, wherein the emitter system includes an emitter printed circuit board and the damping vibrations involves providing a first material on a first side of the emitter printed circuit board, a second elastomeric material on a second side of the emitter printed circuit board that is opposite the first side of the printed circuit board, and a third elastomeric material on a back side of the encoder disc.
